(19) United States
(12) Patent Application Publication
(10) Pub. No.: US 2015/0104677 A1
(43) Pub. Date: Apr. 16, 2015

(54) BATTERY PACK

(71) Applicant: SAMSUNG SDI CO., LTD., Yongin-si (KR)

(72) Inventor: Seok KOH, Yongin-si (KR)

(21) Appl. No.: 14/480,865

(22) Filed: Sep. 9, 2014

(30) Foreign Application Priority Data
Oct. 15, 2013 (KR) 10-2013-0122653

(51) Int. Cl. H01M 10/42; H01M 2/30

(52) U.S. Cl. CPC H01M 10/4257; H01M 2/30
USPC 429/7; 429/178

(57) ABSTRACT

A battery pack includes a battery cell, a protection circuit module, and a case. The battery cell has a terminal. The protection circuit module has a through-hole at a region corresponding to the terminal. The case is coupled to the battery cell and covers the protection circuit module. The protection circuit module includes at least one protrusion adjacent the through-hole.

### CROSS-REFERENCE TO RELATED APPLICATION

Korean Patent Application No. 10-2013-0122653, filed on Oct. 15, 2013, and entitled, “BATTERY PACK,” is incorporated by reference herein in its entirety.

### BACKGROUND

1. Field

One or more embodiments described herein relate to a battery.

2. Description of the Related Art

A battery pack typically includes a protection circuit module to protect a battery cell from over-charging or over-discharging. The battery cell may be a lithium ion secondary battery, and the protection circuit module may include a circuit board having one or more protective elements.

Battery cells have changed over time to be thinner. As a result, the width of the circuit board of the protection circuit module has decreased, along with the width of wire patterns on the circuit board. These patterns include those which carry high current, e.g., charge current and/or discharge current. During high-rate charging of the battery cell, a significant amount of heat may be generated in the wire pattern. This heat may cause the wire patterns to deteriorate or break, thereby rendering the battery pack inoperative.

### SUMMARY

In accordance with one or more embodiments, a battery pack includes a battery cell having a terminal; a protection circuit module having a through-hole at a region corresponding to the terminal; and a case coupled to the battery cell and covering the protection circuit module, wherein the protection circuit module includes at least one protrusion adjacent the through-hole.

The battery pack may include a plurality of protrusions adjacent respective sides of the through-hole. The case may have a receiving groove at a location corresponding to the protrusion. The protrusion may be in a width direction of the protection circuit module.

The protrusion may include a first wire pattern to carry a charge current or a discharge current. The first wire pattern may have substantially a same width and substantially a same thickness as a second wire pattern located in a region that does not include the protrusion. The protection circuit module may have opposing top and bottom surfaces, and the first wire pattern may be on at least one of the top or bottom surfaces.

The protrusion may extend in a thickness direction of the protection circuit module. The protrusion may include a first wire pattern to carry a charge current or a discharge current; and a second wire pattern connected to the first wire pattern in parallel. The protection circuit module may have opposing top and bottom surfaces, and the first and second wire patterns may be formed on at least one of the top or bottom surfaces.

The protrusion may include the first wire pattern to carry a charge current or a discharge current. The first wire pattern may have a width and a thickness different from a width and a thickness of a second wire pattern located in a region which does not include the protrusion. The width of the first wire pattern may be less than the width of the second wire pattern, and the thickness of the first wire pattern may be greater than the width of the second wire pattern.

The protection circuit module may have opposing top and bottom surfaces, and the first wire pattern may be on at least one of the top or bottom surfaces. A conductive tab may electrically connect the battery cell to the protection circuit module at a region corresponding to the through-hole of the protection circuit module.

An insulation holder may be located between the battery cell and protection circuit module, and a width of the protrusion of the protection circuit module may be greater than a width of the insulation holder.

In accordance with another embodiment, a battery pack includes a battery cell including a terminal; and a substrate including a conductive pattern adjacent a hole, wherein the hole is aligned with the terminal and wherein the at least one conductive pattern has a first section with an edge spaced a first distance from a first axis passing through the hole and a second section with an edge spaced a second distance from the first axis, the first distance different from the second distance.

The first and second sections may have substantially equal widths. The hole and second section may be aligned along a second axis substantially perpendicular to the first axis. The first and second sections may carry a charge or discharge current.

### BRIEF DESCRIPTION OF THE DRAWINGS

Features will become apparent to those of skill in the art by describing in detail exemplary embodiments with reference to the attached drawings in which:

FIG. 1 illustrates an embodiment of a battery pack;

FIG. 2 illustrates an exploded view of the battery pack;

FIG. 3 illustrates a partially assembled state of the battery pack;

FIG. 4 illustrates internal circuits the battery pack;

FIGS. 5A and 5B illustrate a hole in a circuit board in the battery pack;

FIG. 6A illustrates an assembly of a top cover and protection circuit module of the battery pack, and FIG. 6B illustrates a bottom view of the top cover;

FIG. 7 illustrates an embodiment of an assembling method of the battery pack;

FIGS. 8A to 8D illustrate another embodiment of a battery pack; and

FIGS. 9A to 9C illustrate another embodiment of a battery pack.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

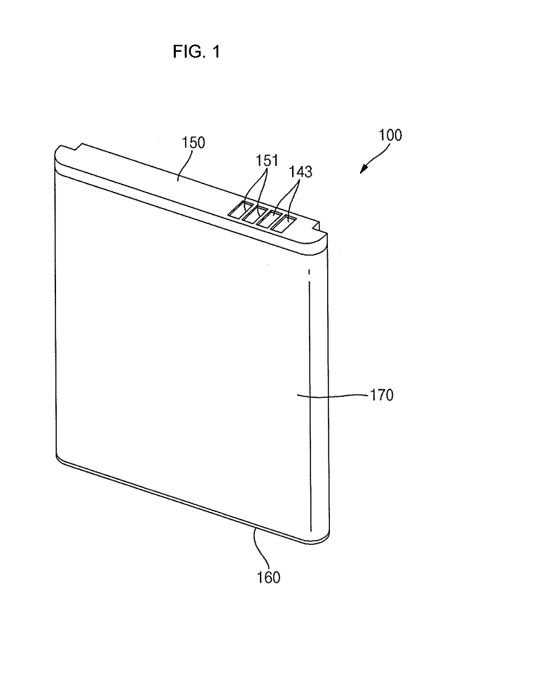

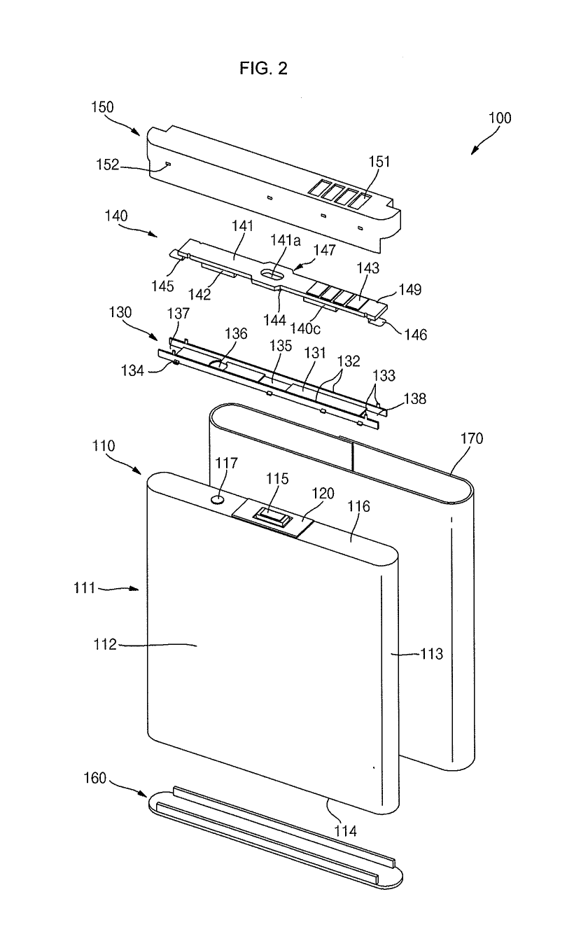

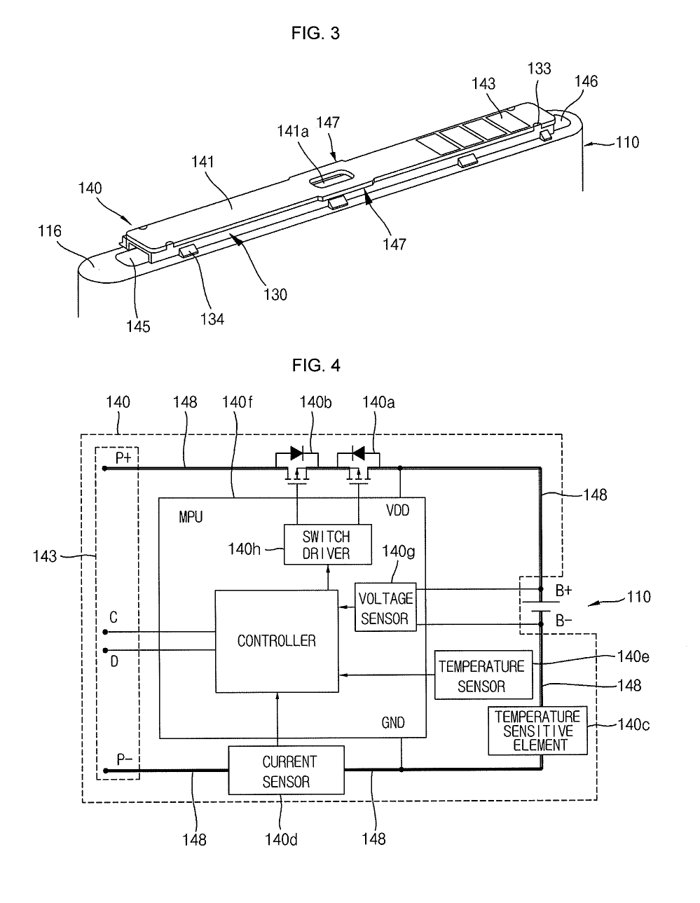

FIG. 1 illustrates an embodiment of a battery pack 100. FIG. 2 illustrates another view of the battery pack shown in FIG. 1. FIG. 3 illustrates a partially assembled view of the battery pack.

Referring to FIGS. 1 to 3, battery pack 100 includes a battery cell 110, an adhesion member 120, an insulation holder 130, a protection circuit module 140, a top cover 150, a bottom cover 160, and a label 170.

The battery cell 110 includes a prismatic can 111, an electrode assembly, an electrode terminal 115, and a cap plate 116. The electrode assembly is received inside the can 111 through an opening at one side of the can 111. The opening may be sealed by cap plate 116. The battery cell 110 has positive and negative electrodes and may constitute a minimum unit of a battery pack for purposes of charging and discharging. The prismatic can 111 may also be considered to be a prismatic case.

The can 111 may have a substantially flat, rectangular, parallelepiped shape with an empty inner space. For example, can 111 may include a pair of long side surfaces 112 having relatively large areas, a pair of short side surfaces 113 connected to the long side surfaces 112 having relatively small areas, and a bottom surface 114 connected to the long side surfaces 112 and short side surfaces 113. The short side surfaces 113 may be curved. The can 111 may be made of aluminum, an aluminum alloy, iron, an iron alloy, stainless steel, or equivalents thereof. In one embodiment, the can 111 serves as an electrode terminal, e.g., a positive electrode terminal. An opening is formed to be opposite to the bottom surface 114.

The electrode assembly may include a positive electrode plate, negative electrode plate, and a separator. The separator may be positioned between the positive and negative electrode plates. The electrode assembly may be wound or stacked, for example, in a jelly-roll configuration. The electrode assembly may be inserted into the can 111 through the opening of the can 111. The electrode assembly is received in the can 111 with an electrolytic solution.

The electrode terminal 115 has lateral surfaces (except for the top and bottom surfaces) surrounded by an insulation gasket, and may pass through cap plate 116 to upwardly protrude and/or to be upwardly exposed. The electrode terminal 115 may be electrically connected to, for example, the negative electrode plate. In this case, the cap plate 116 may be electrically connected to the positive electrode plate. Therefore, the electrode terminal 115 may have a negative polarity, and the cap plate 116 and the can 111 may have a positive polarity.

As described above, the cap plate 116 seals the opening of the can 111 and prevents the electrode assembly and electrolytic solution from falling out of and/or leaking from the can 111. The cap plate 116 may be welded to a top end of the can 111. In addition, an injection hole for injecting an electrolytic solution may be formed in the cap plate 116, and a plug 117 may be formed over the injection hole.

The adhesion member 120 is positioned on the cap plate 116 of the battery cell 110. The adhesion member 120 may partially or entirely cover the cap plate 116. In FIG. 2, the adhesion member 120 is illustrated to cover an outer region of the cap plate 116 in view of the electrode terminal 115, but this is not necessary. The adhesion member 120 serves to adhere the insulation holder 130 on the cap plate 116 of the battery cell 110. The adhesion member 120, for example, may be one selected from the group consisting of a double-sided adhesive tape, a double-sided adhesive film, a liquid adhesive, and equivalents thereof.

The insulation holder 130 is fixed to the battery cell 110. In one embodiment, the insulation holder 130 is adhered to the cap plate 116 of the battery cell 110 through the adhesion member 120.

The insulation holder 130 includes a bottom surface 131 attached to the cap plate 116 by the adhesion member 120. A pair of side surfaces 132 extend in a direction away from the bottom surface 131, and have the protection circuit module 140 mounted thereon. A plurality of first mechanical mating features, e.g., protrusions 133, may diverge (e.g., upwardly protrude) from the pair of side surfaces 132, and may be coupled to protection circuit module 140, thereby preventing the protection circuit module 140 from moving horizontally. Further, a plurality of second mechanical mating features, e.g., protrusions 134, may diverge (e.g., laterally protrude) from the pair of side surfaces 132, for coupling to the top cover 150. This arrangement may prevent the top cover 150 from deviating to the outside.

In addition, the insulation holder 130 may include a first opening 135, a second opening 136, a third opening 137, and a fourth opening 138. These openings are formed on the bottom surface 131 in spaced relation to each other. That is, the first opening 135 is formed at a region that substantially corresponds to a first conductive tab 144 of the protection circuit module 140 and the electrode terminal 115 of the battery cell 110. The second opening 136 is formed at a region substantially corresponding to the plug 117 coupled to the cap plate 116. The third opening 137 and fourth opening 138 are formed at regions substantially corresponding to a second conductive tab 145 and a third conductive tab 146 of the protection circuit module 140. The insulation holder 130 may be made of, for example, an insulating plastic, a surface-insulated metal, or a ceramic.

The protection circuit module 140 on the insulation holder 130 is electrically and mechanically connected to the battery cell 110 in a fixed position. The protection circuit module 140 includes a circuit board 141 having a through-hole 141a formed at a region corresponding to the electrode terminal 115 of the battery cell 110. The first conductive tab 144 is attached to a region corresponding to the through-hole 141a. The second and third conductive tabs 145 and 146 are attached to opposite ends of the protection circuit module 140.

A plurality of protective elements 142 are mounted on a bottom surface of the protection circuit module 140. A plurality of external terminals 143 may be formed on a top surface of the protection circuit module 140. A temperature sensitive element 140c may be installed on the circuit board 141. The temperature sensitive element 140c may reduce current flow into and/or out of the battery cell according to an increase in temperature.

The circuit board 141 may be a rigid circuit board, a flexible circuit board, or equivalents thereof. In addition, a plurality of third mechanical mating features, e.g., grooves 149 that are complementary to the first mechanical mating features, may engage the first protrusions 133 on the insulation holder 130 may be formed in the circuit board 141.

As described above, the first conductive tab 144 may be welded to the electrode terminal 115 of the battery cell 110. The second and third conductive tabs 145 and 146 may be welded to the cap plate 116 of the battery cell 110.

The circuit board 141 may further include fourth mating features, e.g., an outwardly protruding protrusion 147 around the through-hole 141a. The protrusion 147 may be formed at only one side of the through-hole 141a, or two protrusions 147 may be formed at respective opposing sides of the throughshole 141a. In one embodiment, the protrusion 147 may have a width greater than that of the insulation holder 130. Accordingly, the protrusion 147 of the circuit board 141 may protrude to the exterior of the insulation holder 130.

At least one wire pattern may be provided to carry high current such as a charge current and/or a discharge current. The wire pattern may be formed on the protrusion 147. In one embodiment, the wire pattern may extend in a length direction of the circuit board 141 through protrusion 147. The through-hole 141a may be formed in the circuit board 141 to allow the first conductive tab 144 to be welded to the electrode terminal 115 of the battery cell 110. As a result of this arrangement, an area of the circuit board 141 is reduced.

However, because the protrusion 147 is formed around the through-hole 141a, a width of the wire pattern is not reduced. Therefore, during high-rate charging of the battery cell 110, an large amount of heat is not generated from the wire pattern, and therefore the wire pattern will not break to create an open circuit. The wire pattern may also be called a circuit pattern, a conductive trace, or a conductor, in some cases. During fabrication, a welding tool may pass through the through-hole 141a.

The top cover 150 covers an upper region of the battery cell 110. The bottom cover 160 covers a lower region of the battery cell 110. In one embodiment, the top cover 150 covers the protection circuit module 140 and the insulation holder 130, while also covering a portion of the long side surface 112 of the battery cell 110. In an alternative embodiment, the top cover 150 may include a plurality of main through-holes 151, to externally expose a plurality of external terminals 143 in the protection circuit module 140. The top cover 150 may include a plurality of sub through-holes 152 for coupling with the second protrusions 134 on the insulation holder 130.

The top cover 150 and the bottom cover 160 may be pre-formed using a plastic resin. Thereafter, the top cover 150 may be assembled with the protection circuit module 140 and the insulation holder 130 positioned above the battery cell 110 in an interference fit manner. Also, the bottom cover 160 may be coupled to a lower region of the battery cell 110 by an interference fit, e.g., friction. In addition, the top cover 150 and the bottom cover 160 may be formed by placing the protection circuit module 140, the insulation holder 130, and the battery cell 110 in a mold, followed by injecting a melted plastic resin into the mold and cooling.

The label 170 may surround the entire portion of long and short side surfaces 112 and 113, and may also surround portions of the top cover 150 and bottom cover 160. Therefore, the protection circuit module 140 and insulation holder 130, positioned inside the top cover 150, may not be externally exposed. The top cover 150 and bottom cover 160 are firmly and stably fixed to the battery cell 110. An outer surface of the label 170 may be printed with information regarding, for example, a product name, a trademark, product content, a size, a capacity, a production date, and/or methods of production, marketing and use of a product. An adhesive layer is coated on an inner surface of the label 170. The label 170 may be, for example, a surface-treated polypropylene film or a surface-treated polyester film.

A hard external case made of a rigid plastic material may be used, instead of the label 170. In this case, an adhesive may be coated on an inner surface of the hard external case, thereby integrally coupling the hard external case, the battery cell 110, the top cover 150, and the bottom cover 160.

In accordance with the aforementioned embodiment, the outwardly protruding protrusion 147 is formed around the through-hole 141a of the circuit board 141 constituting the protection circuit module 140. Through this arrangement, a sufficiently wide wire pattern is provided for carrying high current on protrusion part 147. Therefore, even if battery cell 110 is charged and/or discharged at a high rate, heat is not to a level sufficient to melt or otherwise break the wire pattern to cause an open circuit.

FIG. 4 illustrates an example of the internal circuits of the battery pack 100 in FIG. 1. As illustrated in FIG. 4, the protection circuit module 140 is electrically connected to the battery cell 110. The protection circuit module 140 includes a charge switch 140a, a discharge switch 140b, a temperature sensitive element 140c, a current sensor 140d, a temperature sensor 140e, and a microprocessor unit 140f. The charge switch 140a and the discharge switch 140b are respectively connected to a positive electrode B+ and a terminal P+ of the battery cell 110.

The temperature sensitive element 140c and current sensor 140d are connected between a negative electrode B− and a terminal P− of the battery cell 110. The temperature sensor 140e senses a temperature of the battery cell 110.

The protection element 142 may include microprocessor unit 140f. In one embodiment, the microprocessor unit 140f controls a switch driver 140h by sensing a voltage of the battery cell 110 using a voltage sensor 140g. The microprocessor unit 140f may sense a current of the battery cell 110 using the current sensor 140d. The switch driver 140h controls on/off states of the charge switch 140a and discharge switch 140b. In addition, information regarding the capacity or temperature of the battery cell 110 is transmitted to an external set through terminals C and D. The P+, P−, C and D terminals may be correspond to external terminal(s) 143.

A path for charge current and/or discharge current (e.g., a high current path) is formed between the positive electrode B+ and terminal P+ of the battery cell 110, and between the negative electrode B− and terminal P− of the battery cell 110. The high current path may be implemented by the wire pattern 148 of the circuit board 141. In one embodiment, the wire pattern 148 (including a first wire pattern 148a and/or a second wire pattern 148b) may correspond to the high current path of the charge current and/or discharge current flowing between the positive electrode B+ and terminal P+ of the battery cell 110 and between the negative electrode B− and terminal P− of the battery cell 110.

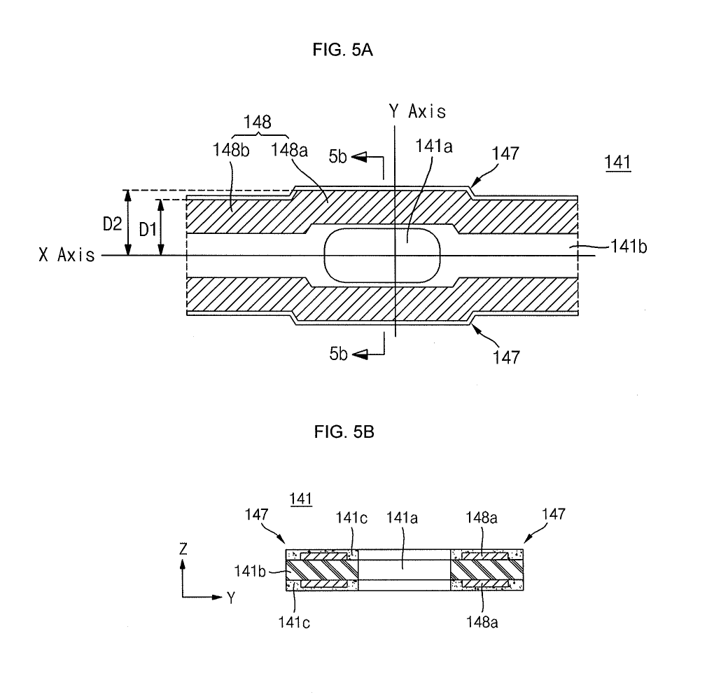

FIGS. 5A and 5B illustrate a periphery of the through-hole 141a of the circuit board in the battery pack in FIG. 1. As illustrated in FIG. 5A, the circuit board 141 may serve as one component of the protection circuit module 140 and may include at least one protrusion 147 that protrudes outwardly by a predetermined length from the periphery of the through-hole 141a. In one embodiment, two protrusion 147 are formed at respective, opposing sides of the through-hole 141a.

The protrusion 147 may be formed in a width direction of the protection circuit module 140, i.e., circuit board 141. In other words, the circuit board 141 has a thickness (e.g., in the Z-axis direction), a length (e.g., in the Y-axis direction), and a width (e.g., in the X-axis direction). The X-, Y- and Z-axis directions may be perpendicular to each other. In an alternative embodiment, the protrusion 147 may be formed in a thickness direction of the circuit board 141, rather than in the width direction of circuit board 141.

The protrusion 147 serves to increase the size of the first wire pattern 148a, e.g., if protrusion 147 is not provided, a region in which (e.g., a width of) the first wire pattern 148a will be small. For example, without protrusion part 147, the width of the first wire pattern 148a will be smaller than the width of the second wire pattern 148b. Accordingly, during high-rate charging and/or discharging of the battery cell 110, a large amount of heat may be generated in the first wire pattern 148a, thereby melting or otherwise causing the first wire pattern 148a to break resulting in an open circuit.

In one embodiment, the outwardly protruding protrusion 147 is formed around the through-hole 141a. The first wire pattern 148a may have an outer edge spaced at a distance D2 from an X axis passing through the through-hole 141a. The second wire pattern 148b may have an outer edge spaced at a distance D1 from the X axis. In one embodiment, distance D2 is greater than distance D1. Also, first wire pattern 148a may be aligned with the through-hole 141a along a Y axis, which crosses (e.g., is perpendicular to) the X axis.

The first wire pattern 148a may have the same width along the X axis as the second wire pattern 148b. Therefore, even when the battery cell 110 is charged and/or discharged at a high rate, a large amount of heat is not generated in the first wire pattern 148a and the first wire pattern 148a is not broken, cut, melted, or otherwise compromised. In other embodiments, the first wire pattern 148a and the second wire pattern 148b may have different widths.

As illustrated in FIG. 5B, as one component of the protection circuit module 140, the circuit board 141 may include an insulation layer 141b having a substantially planar top surface and a substantially planar, opposing bottom surface. The first wire pattern 148a may be formed on each of the top and bottom surfaces of the insulation layer 141b. In one embodiment, the first wire pattern 148a may be formed on only one of the top or bottom surfaces of the insulation layer 141b.

The first and second wire patterns 148a and 148b are covered by the protection layer 141c to be protected from external environmental factors. The first and second wire patterns 148a and 148b may be made of a conductive material, e.g., but not limited to copper or a copper alloy.

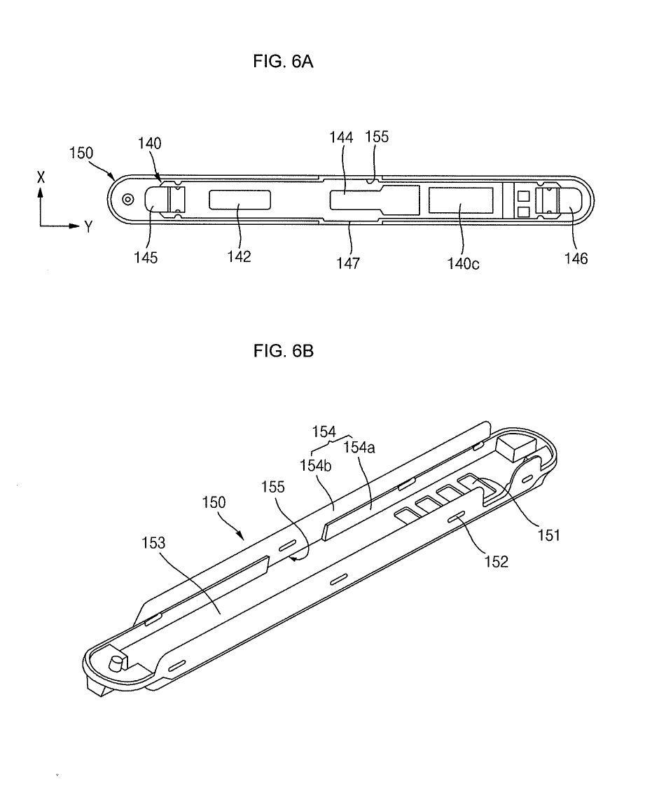

FIG. 6A illustrates top cover 150 and protection circuit module 140 in an assembled state, and FIG. 6B is a bottom view of the top cover 150. As illustrated in FIGS. 6A and 6B, the top cover 150 covers the protection circuit module 140. In addition, the protection circuit module 140 is assembled with top cover 150. Because the fourth mechanical mating features, e.g., protrusion 147, is formed on the protection circuit module 140, a fifth mechanical mating feature, e.g., receiving groove 155, may be formed in the top cover 150 to receive the protrusion 147.

That is, the top cover 150 has a main body 153 and a sub-body 154. The main body 153 covers a relatively wide, long side surface of the protection circuit module 140. The sub-body 154 extends from the main body 153 and covers a relatively narrow, short side surface of protection circuit module 140. The main body 153 has a plurality of main through-holes 151 formed to allow one or more corresponding external terminals 143 of the protection circuit module 140 to be exposed. In addition, the sub-body 154 may have a plurality of sub-through-holes 152 to be engaged with second protrusions 134 of an insulation holder 130.

The receiving groove 155 is formed in sub-body 154 at a region corresponding to the protrusion 147 of the protection circuit module 140, to receive the protrusion 147. More specifically, the sub-body 154 may cover the protection circuit module 140, and may have a first sub-body 154a to contact cap plate 116 and a second sub-body 154b extending from the first sub body 154a to contact can 111.

The first sub-body 154a may not be removed from or may not be formed in a predetermined region, to thereby form receiving groove 155 to receive protrusion part 147. That is, the second sub-body 154b may be directly connected to the main body 153, and the receiving groove 155 may be formed at a region at which the second sub-body 154b is directly connected to the main body 153. In one embodiment, the first sub-body 154a and the second sub-body 154b may have different heights.

Even if the protrusion 147 is formed on the protection circuit module 140 in the above-described manner, the receiving groove 155 allows the top cover 150 to be easily assembled with the protection circuit module 140. In addition, the receiving groove 155 of the top cover 150 offsets a protruding length of the protrusion part 147 of the protection circuit module 140, thereby preventing the overall thickness of the battery pack from increasing.

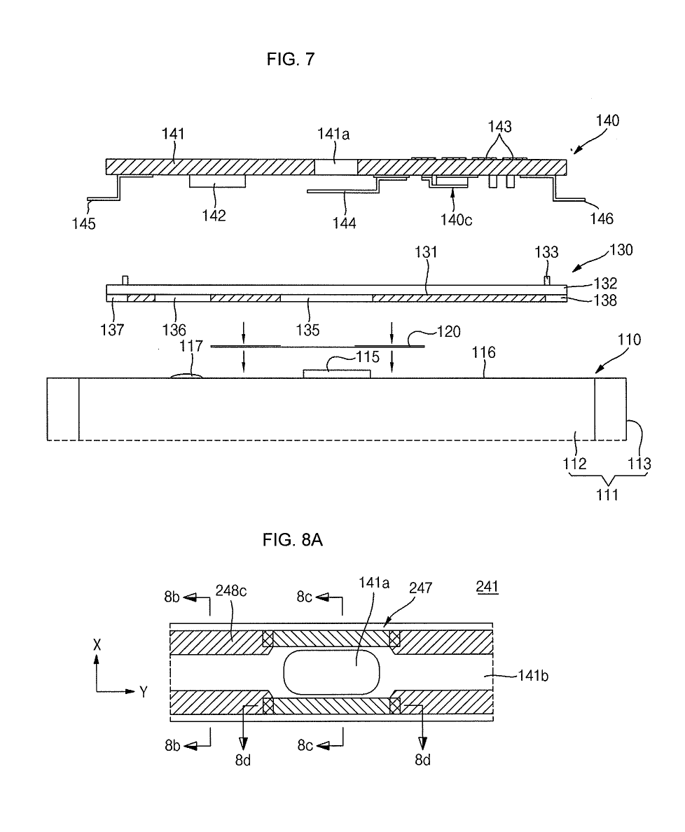

FIG. 7 illustrates an embodiment of an assembling method of a battery cell and protection circuit module in a battery pack, for example, as illustrated in FIG. 1. As illustrated in FIG. 7, the insulation holder 130 is mechanically attached to the battery cell 110 using adhesion layer 120. The protection circuit module 140 is then placed on the insulation holder 130. In addition, the first conductive tab 144 of the protection circuit module 140 is welded to the electrode terminal 115 of the battery cell 110. The welding tool passes through the through-hole 141a to weld the first conductive tab 144 to the electrode terminal 115.

The first conductive tab 144 passes through the first through-hole 135 of the insulation holder 130. In addition, the second conductive tab 145 and third conductive tab 146 pass through third and fourth through-holes 137 and 138 of the insulation holder 130, to then be directly welded to the cap plate 116 of the battery cell 110. The plurality of protective elements 142 (e.g., a microprocessor unit, temperature sensitive element 140c, or the like) may be mounted on the circuit board 141.

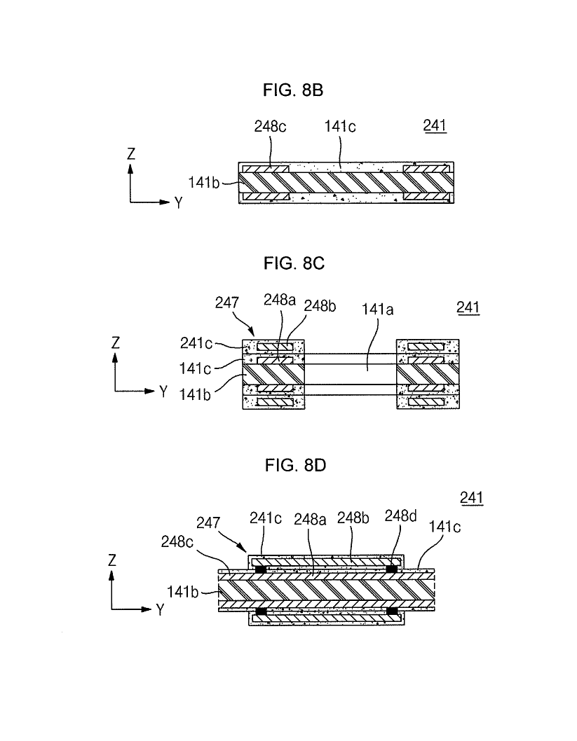

FIGS. 8A to 8D illustrate the periphery of a through-hole of a circuit board in another embodiment of a battery pack. As illustrated in FIGS. 8A to 8D, the protection circuit module 140 may include a protrusion 247 formed in a thickness direction, e.g., the Z direction. The protrusion 247 may include a first wire pattern 248a to carry a charge current and/or a discharge current, and a second wire pattern 248b connected to the first wire pattern 248a, e.g., in parallel.

While protrusion 147 in FIG. 5A may correspond to an extension region of the circuit board 141, the protrusion 247 in FIGS. 8A to 8D is formed on the circuit board 241. Also, the first and second wire patterns 248a and 248b may be connected to each other, e.g., in parallel. Also, as illustrated in FIGS. 8A to 8D, the circuit board 241 may have a uniform width, i.e., along the X direction, both in a region which includes through-hole 141a and in a region that does not include through-hole 141a. The first and second wire patterns 248a and 248b may be formed on top and bottom surfaces of the circuit board 241, respectively, or may be formed on at least one of the top or bottom surfaces of the circuit board 241.

The first and second wire patterns 248a and 248b constituting the protrusion part 247 formed in the thickness, i.e., Z, direction of the circuit board 241 will now be described in more detail. (For brevity, the protection layers 141c and 241c are not shown in FIG. 8A.)

The first wire pattern 248a is formed on a surface of the insulation layer 141b forming the circuit board 241 and is covered by the first protection layer 141c. The second wire pattern 248b is formed on the first wire pattern 248a, connected to the first wire pattern 248a in parallel, and is covered by the second protection layer 241c. The first wire pattern 248a and second wire pattern 248b may be electrically connected to each other, for example, by a solder 248d.

In addition, the second wire pattern 248b may be a flexible board surrounded by the insulation layer 241c, but this is not necessary. A third wire pattern 248c (which is electrically connected to the first and second wire patterns 248a and 248b) may further be formed at exterior sides of the first and second wire patterns 248a and 248b. Because a width of the third wire pattern 248c is not affected by the through-hole 141a, the third wire pattern 248c may have a greater width than the first and second wire patterns 248a and 248b. That is, widths of the first and second wire patterns 248a and 248b may be smaller than the width of the third wire pattern 248c. However, in one embodiment, a sum of thicknesses of the first and second wire patterns 248a and 248b may be greater than a thickness of the third wire pattern 248c.

Because the sum of the thicknesses of the first and second wire patterns 248a and 248b may be greater than the thickness of the third wire pattern 248c, a large amount of heat is not generated from the first and second wire patterns 248a and 248b. This large amount of heat is not generated even when the widths of the first and second wire patterns 248a and 248b around through-hole 141a are smaller than the width of the third wire pattern 248c. Moreover, this large amount of heat is not generated, even when high-rate charging of the battery cell 110 and the first and second wire patterns 248a and 248b would otherwise result in breaking or cutting smaller-width wire patterns. In one embodiment, the overall cross-sectional area of the first and second wire patterns 248a and 248b may be the same as a cross-sectional area of the third wire pattern 248c. In other embodiments, these cross-sectional areas may be different.

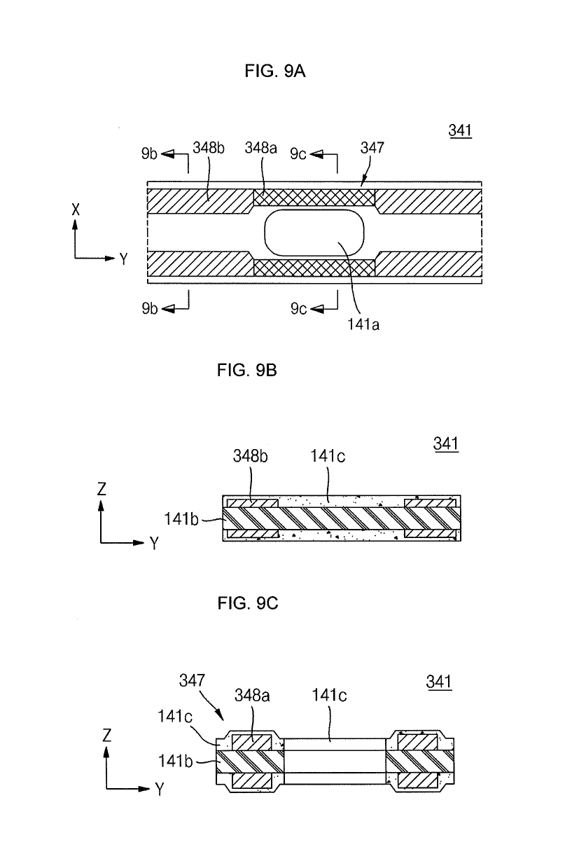

FIGS. 9A to 9C illustrate the periphery of a through-hole of a circuit board in another embodiment of a battery pack. As illustrated in FIGS. 9A to 9C, protrusion 347 may be formed in the thickness direction of the circuit board 341 of the protection circuit module 140. The protrusion part 347 may include a first wire pattern 348a to carry a charge current and/or a discharge current.

The first wire pattern 348a may have a width and thickness different from those of a second wire pattern 348b without the protrusion 347. That is, the first wire pattern 348a may have a width smaller than a width of the second wire pattern 348b, and may have a thickness greater than that of the second wire pattern 348b.

In addition, the first wire pattern 348a may be formed on top and bottom surfaces of the circuit board 341, respectively, or may be formed on at least one of the top or bottom surfaces of the circuit board 341.

Because the thickness of the first wire pattern 348a is greater than the thickness of the second wire pattern 348b (even when the width of the first wire pattern 348a around the throughhole 141a is smaller than the width of the second wire pattern 348b), a large amount of heat is not generated from the first wire pattern 348a. Thus, even when high-rate charging of the battery cell 110 is performed, because the first wire pattern 348a is wider, it does not melt or break. In one embodiment, the cross-sectional area of the first wire pattern 348a may be the same as a cross-sectional area of the second wire pattern 348b. In other embodiments, these cross-sectional areas may be different.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A battery pack, comprising:
a battery cell having a terminal;
a protection circuit module having a through-hole at a region corresponding to the terminal; and
a case coupled to the battery cell and covering the protection circuit module, wherein the protection circuit module includes at least one first mechanical mating feature adjacent the through-hole.

2. The battery pack as claimed in claim 1, further comprising:
a plurality of first mechanical mating features adjacent respective sides of the through-hole.

3. The battery pack as claimed in claim 1, wherein the case has a second mechanical mating feature complementary to the first mechanical mating feature at a location corresponding to the protrusion.

4. The battery pack as claimed in claim 1, wherein the first mechanical mating feature is in a width direction of the protection circuit module.

5. The battery pack as claimed in claim 1, wherein the first mechanical mating feature includes a first wire pattern to carry a charge current or a discharge current.

6. The battery pack as claimed in claim 5, wherein the first wire pattern has substantially a same width and substantially a same thickness as a second wire pattern located in a region that does not include the first mechanical mating feature.

7. The battery pack as claimed in claim 5, wherein:
the protection circuit module has opposing top and bottom surfaces, and
the first wire pattern is on at least one of the top or bottom surface.

8. The battery pack as claimed in claim 1, wherein the first mechanical mating feature is in a thickness direction of the protection circuit module.

9. The battery pack as claimed in claim 8, wherein the first mechanical mating feature includes:
a first wire pattern to carry a charge current or a discharge current; and
a second wire pattern connected to the first wire pattern in parallel.

10. The battery pack as claimed in claim 9, wherein:
the protection circuit module has opposing top and bottom surfaces, and
the first and second wire patterns are formed on at least one of the top or bottom surfaces.

11. The battery pack as claimed in claim 8, wherein the first mechanical mating feature includes the first wire pattern to carry a charge current or a discharge current.

12. The battery pack as claimed in claim 11, wherein the first wire pattern has a width and a thickness different from a width and a thickness of a second wire pattern located in a region which does not include the first mechanical mating feature.

13. The battery pack as claimed in claim 12, wherein:
the width of the first wire pattern is less than the width of the second wire pattern, and
the thickness of the first wire pattern is greater than the width of the second wire pattern.

14. The battery pack as claimed in claim 13, wherein:
the protection circuit module has opposing top and bottom surfaces, and
the first wire pattern is on at least one of the top or bottom surfaces.

15. The battery pack as claimed in claim 1, further comprising:
a conductive tab to electrically connect the battery cell to the protection circuit module at a region corresponding to the through-hole of the protection circuit module.

16. The battery pack as claimed in claim 1, further comprising:
an insulation holder between the battery cell and protection circuit module, wherein a width of the first mechanical mating feature of the protection circuit module is greater than a width of the insulation holder.

17. A battery pack, comprising:
a battery cell including a terminal; and
a substrate including a conductive pattern adjacent a hole,
wherein the hole is aligned with the terminal and wherein the at least one conductive pattern has a first section with an edge spaced a first distance from a first axis passing through the hole and a second section with an edge spaced a second distance from the first axis, the first distance different from the second distance.

18. The battery pack as claimed in claim 17, wherein the first and second sections have substantially equal widths.

19. The battery pack as claimed in claim 17, wherein the hole and second section are aligned along a second axis substantially perpendicular to the first axis.

20. The battery pack as claimed in claim 17, the first and second sections carry charge or discharge current.
